(19) United States
(12) Patent Application Publication
(10) Pub. No.: US 2023/0123231 A1
(43) Pub. Date: Apr. 20, 2023

(54) SYSTEMS AND METHODS FOR ENTERPRISE DATA ANALYSIS AND FORECASTING

(71) Applicants: Andrew Palosi, Thousand Oaks, CA (US); Ismael Valdez, Huntington Beach, CA (US); Brianna Skiffington, Winter Garden, FL (US)

(72) Inventors: Andrew Palosi, Thousand Oaks, CA (US); Ismael Valdez, Huntington Beach, CA (US); Brianna Skiffington, Winter Garden, FL (US)

(73) Assignee: Data Cube, Inc., Thousand Oaks, CA (US)

(21) Appl. No.: 17/504,695

(22) Filed: Oct. 19, 2021

(51) Int. Cl. G06Q 10/04; G06Q 10/06; G06F 16/26

(52) U.S. Cl. CPC G06Q 10/04; G06Q 10/06315; G06F 16/26; G06Q 10/06375

(57) ABSTRACT

A system for enterprise data analysis and forecasting is disclosed, including at least one user computing device in operable connection with a network. An application server is in operable communication with the user network to host an application program for providing a system for enterprise data analysis and enterprise data forecasting. The application program includes a user interface module for providing access to the application program through the user computing device. A machine learning engine receives a plurality of data points stored in one or more databases each in operable communication with the application program. The machine learning engine processes the data points and transmits the data points to a report module, configured to generate one or more reports. The reports permit a user to analyze and forecast enterprise data.

### TECHNICAL FIELD

The embodiments generally relate to computerized systems and methods for data analysis and data forecasting.

### BACKGROUND

Many businesses continuously seek to identify new ways to grow their business, whether through existing client relationships or by connecting with new prospective clients. Further, many businesses seek to increase profits by increasing the efficiency in which they perform various tasks. Often, the information needed to have a complete view of an enterprise's operations is present in various locations without a centralized database which can be accessed to analyze various aspects of the business. For example, sales data and order processing information may be stored remotely from one another, delaying access to each data source.

Often, as an enterprise increases in size, its data becomes increasingly disparate. This leaves managers and executives out of touch when analyzing key performance indicators (KPI's) in relation to more granular data points. To gain access to useful data, businesses spend significant time and money to compile data and generate reports and visual representations of the data which can be used to make future business decisions. However, this information cannot be obtained and processed in real-time causing inefficiency when making business decisions.

### SUMMARY OF THE INVENTION

This summary is provided to introduce a variety of concepts in a simplified form that is disclosed further in the detailed description of the embodiments. This summary is not intended to identify key or essential inventive concepts of the claimed subject matter, nor is it intended for determining the scope of the claimed subject matter.

The embodiments provided herein relate to a system for enterprise data analysis and forecasting, including at least one user computing device in operable connection with a network. An application server is in operable communication with the user network to host an application program for providing a system for enterprise data analysis and enterprise data forecasting. The application program includes a user interface module for providing access to the application program through the user computing device. A machine learning engine receives a plurality of data points stored in one or more databases each in operable communication with the application program. The machine learning engine processes the data points and transmits the data points to a report module, configured to generate one or more reports. The reports permit a user to analyze and forecast enterprise data.

The system allows for dynamic data modeling, wherein variables can be adjusted and analyzed in real time to project the outcome of hypothetical inputs to ensure real-life optimizations will yield desired results. Models may be trained to reach consistent accuracy based off of historically correlated features in data sets, and then forecast the data based on the static features. In one aspect, the data may be manipulated to allow users to understand and simulate implications of particular decisions and downstream consequences of each decision.

Prior existing technologies are limited to reporting, visualizing, and performing calculations on their corresponding data in mostly static environments. For example, a CRM system includes reports where certain metrics can be added to graphs or tables but is not able to blend multiple sources of data or easily toggle between views. While any mathematical calculation could manually be performed to blend data from multiple sources, it would not be possible to replicate in real time nor with the speed, efficiency or accuracy of this invention nor at the complexity in calculations this meets with ease for non-traditional metrics defined by an individual business based on their own data and measurements for success.

In one aspect, a display module is provided to display the report via an I/O device of a computer system.

In one aspect, the one or more reports include actual revenue and projected revenue.

In one aspect, a sales database stores a plurality of sales metrics. The plurality of sales metrics are transmitted to the machine learning engine to process the plurality of sales metrics and to generate a sales report.

In one aspect, a marketing database stores a plurality of marketing metrics. The plurality of marketing metrics are transmitted to the machine learning engine to process the plurality of marketing metrics and to generate a marketing report.

In one aspect, a report database stores the one or more reports to permit the one or more reports to be viewed by the user.

In one aspect, a technical database stores a plurality of technical support metrics. The technical support metrics are transmitted to the machine learning engine to process the plurality of technical support metrics and to generate a technical support report.

In one aspect, a review database stores a plurality of reviews provided by a third-party computing device. The plurality of reviews are transmitted to the machine learning engine to process the plurality of reviews and to generate a review report.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a block diagram of a computing system, according to some embodiments;

FIG. 2 illustrates a block diagram of a computing system and an application program, according to some embodiments;

FIG. 3 illustrates a block diagram of the application program and databases, according to some embodiments;

FIG. 4 illustrates a block diagram of the data flow through the system, according to some embodiments;

FIG. 5 illustrates a screenshot of a report generated by the report module, according to some embodiments; and

FIG. 6 illustrates a flowchart of a process for generating a report, according to some embodiments.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood thereon.

Before describing in detail exemplary embodiments, it is noted that the embodiments reside primarily in combinations of components and procedures related to the system. Accordingly, the system components have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein.

In this disclosure, the various embodiments may be a system, method, and/or computer program product at any possible technical detail level of integration. A computer program product can include, among other things, a computer-readable storage medium having computer-readable program instructions thereon for causing a processor to carry out aspects of the present disclosure.

In general, the embodiments described herein relate to a system and method for providing analysis of business data to determine valuable business insights. The system aids in the elucidation of both historical and future opportunities to optimize performance of the business via aspects such as establishing processes to eliminate anomalies, finding opportunities to improve training, benchmarks by which to assess team performance, comparing campaigns, etc. The system surpasses the utility of static reports and graphs by functioning as something which is visible for various members of the enterprise via easy access sharing and is dynamic via adjustable sorting views. Further, the information is contextualized by showing change over time, adaptable by KPI flexibility, observant and intelligent with anomaly detection, and interactive with animations and sounds.

The system allows for dynamic data modeling, wherein variables can be adjusted and analyzed in real time to project the outcome of hypothetical inputs to ensure real-life optimizations will yield desired results. Models are trained to reach consistent accuracy based off of historically correlated features in data sets, and then forecast the data based on the static features. The data may be manipulated to understand implications of particular decisions and downstream consequences of each decision. For example, in a vision board interface provided by the system, users can see their forecasted sales or revenue for the remainder of the calendar year. Further, the user may also change inputs to see the outcome, such as doubling a booking rate or close rate to view the projected outcome (e.g., doubling revenue). In another example, a user may input a data point such as increasing an administrative team's size which could eliminate cancellations and also increase revenue. Each of these adjustments giving the user the ability to measure the potential ramifications of their business decisions in order to more effectively prioritize their efforts on improving each one for maximum impact. In some embodiments, the vision board is generated by a machine learning algorithm.

Additionally, the system provided in the embodiments described herein may detect both positive and negative anomalies such as performance records with rewarding notifications, animations, and sounds. In another example, the system may can alert to unusual stats which could adversely affect performance if they persist and catch the attention of a supervisor who could mitigate the issues with corrective action when notified. This highly interactive aspect is responsive and dynamic, therefore more ingrained in the business operations than a simple static visual representation such as a 2-dimensional graph alone.

As used herein, the term “user” may refer to any user in communication with the system including which is employed by or otherwise associated with the enterprise. For example, the user may be sales personnel, marketing personnel, technical staff, executives, management, shipping and receiving personnel, etc. The term “user” may also include administrative users.

The user can access the system using web applications, mobile applications, computer program products, and similar computer implemented systems. Data may be supported and further processed by machine learning algorithms to forecast performance and detect anomalies. As technology persists, it will also contextualize data by real time calls via verbal commands and augmented reality applications wherein with facial recognition it will recall data related to the subject within peripheral view.

The system is operable to perform data acquisition, data parsing, and filtering of data. Further, the system may elaborate data such as by processing the acquired data to fit the operational requirements. Processed data may be stored as reports or as raw processed data to allow for future analysis and processing.

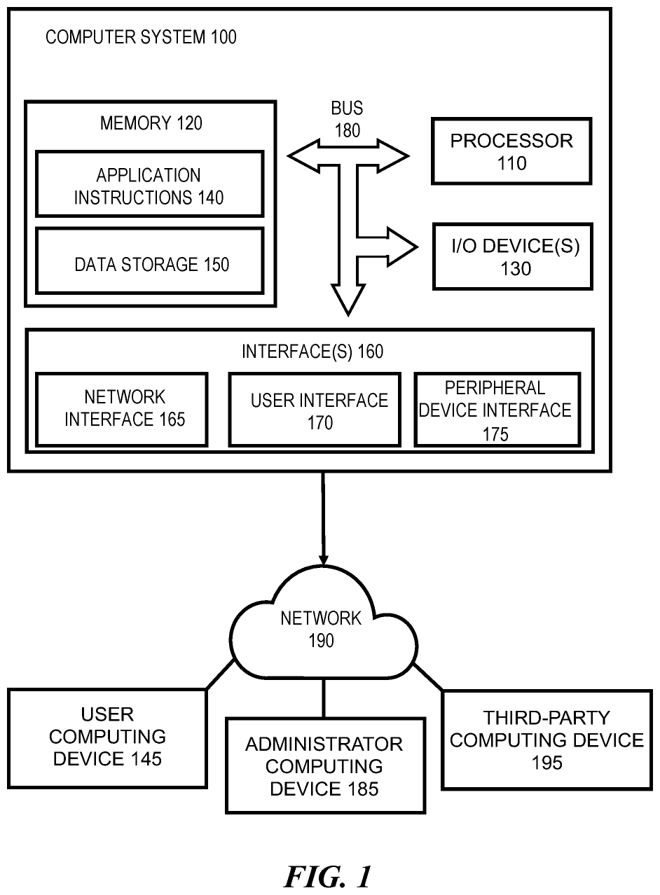

FIG. 1 illustrates an example of a computer system 100 that may be utilized to execute various procedures, including the processes described herein. The computer system 100 comprises a standalone computer or mobile computing device, a mainframe computer system, a workstation, a network computer, a desktop computer, a laptop, or the like. The computing device 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes one or more processors 110 coupled to a memory 120 through a system bus 180 that couples various system components, such as an input/output (I/O) devices 130, to the processors 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 100 includes one or more input/output (I/O) devices 130, such as video device(s) (e.g., a camera), audio device(s), and display(s) are in operable communication with the computer system 100. In some embodiments, similar I/O devices 130 may be separate from the computer system 100 and may interact with one or more nodes of the computer system 100 through a wired or wireless connection, such as over a network interface.

Processors 110 suitable for the execution of computer readable program instructions include both general and special purpose microprocessors and any one or more processors of any digital computing device. For example, each processor 110 may be a single processing unit or a number of processing units and may include single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 120 includes computer-readable application instructions 150, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., C, C++, C#, JAVA, JAVASCRIPT, PERL, etc.).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include, or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computer system 100 includes one or more interfaces 160 that allow the computer system 100 to interact with other systems, devices, or computing environments. In some embodiments, the computer system 100 comprises a network interface 165 to communicate with a network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet). The Internet refers to the specific collection of networks and routers communicating using an Internet Protocol (“IP”) including higher level protocols, such as Transmission Control Protocol/Internet Protocol (“TCP/IP”) or the Uniform Datagram Packet/Internet Protocol (“UDP/IP”).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, the computer system 100 may include a user computing device 145, an administrator computing device 185 and a third-party computing device 195 each in communication via the network 190. The user computing device 145 may be utilized by any user associated with an enterprise. The administrator computing device 185 may include users having administrative functions, or by managers and/or executives of the enterprise. The third-party computing device 195 may be utilized by third parties to receive communications from the user computing device and/or administrative computing device 185, to transmit communications to the user via the network, and otherwise interact with the various functionalities of the system.

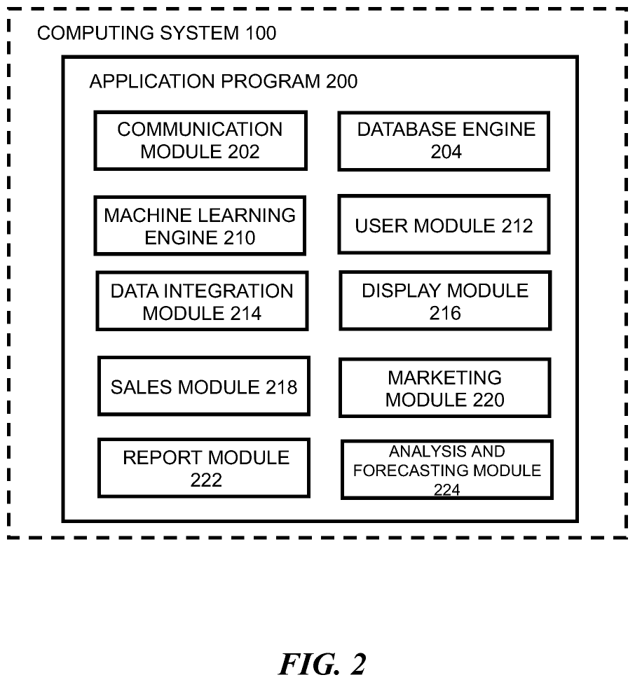

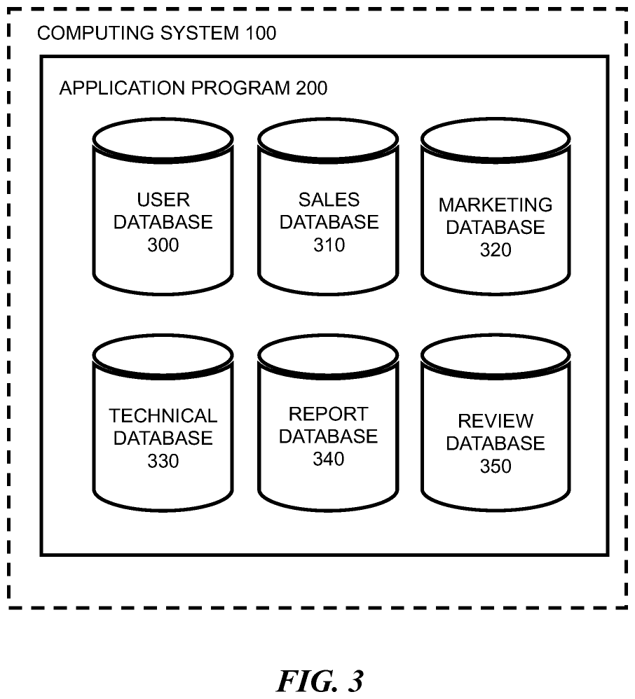

FIGS. 2 and 3 illustrate an example computer architecture for the application program 200 operated via the computing system 100. The computer system 100 comprises several modules and engines configured to execute the functionalities of the application program 200, and a database engine 204 configured to facilitate how data is stored and managed in one or more databases. In particular, FIG. 2 is a block diagram showing the modules and engines needed to perform specific tasks within the application program 200, and FIG. 3 is a block diagram showing the various databases utilized by the various modules.

Referring to FIG. 2, the computing system 100 operating the application program 200 comprises one or more modules having the necessary routines and data structures for performing specific tasks, and one or more engines configured to determine how the platform manages and manipulates data. In some embodiments, the application program 200 comprises one or more of a communication module 202, a database engine 204, a machine learning engine 210, a user module 212, a data integration module 214, a display module 216, a sales module 218, a marketing module 220, a report module 222, and an analysis and forecasting module 224.

In some embodiments, the communication module 202 is configured for receiving, processing, and transmitting a user command and/or one or more data streams. In such embodiments, the communication module 202 performs communication functions between various devices, including the user computing device 145, the administrator computing device 185, and a third-party computing device 195. In some embodiments, the communication module 202 is configured to allow one or more users of the system, including a third-party, to communicate with one another. In some embodiments, the communications module 202 is configured to maintain one or more communication sessions with one or more servers, the administrative computing device 185, and/or one or more third-party computing device(s) 195. In some embodiments, the communication module 202 allows each user to transmit and receive information which may be used by the system.

In some embodiments, a database engine 204 is configured to facilitate the storage, management, and retrieval of data to and from one or more storage mediums, such as the one or more internal databases described herein. In some embodiments, the database engine 204 is coupled to an external storage system. In some embodiments, the database engine 204 is configured to apply changes to one or more databases. In some embodiments, the database engine 204 comprises a search engine component for searching through thousands of data sources stored in different locations. The database engine 204 allows each user and module associated with the system to transmit and receive information stored in various databases.

In some embodiments, the machine learning engine 210 receives information from the application program 200 and databases in communication therewith to provide projected future business analytics based off of historical information stored in the application program. For example, the machine learning engine 210 may allow users to forecast sales data for an upcoming fiscal quarter by receiving real-time sales information from the sales database as well as historical sales trends from previous years. In another example, the machine learning engine 210 may determine a more efficient sales cycle or shipping logistics based on information received from an order processing database, sales database, etc.

In some embodiments, the user module 212 facilitates the creation of a user account for the application system. The user module 212 may allow the user to create user preferences, establish user credentials, set user goals related to the enterprise, define the user's role within the enterprise, etc. The user module 212 may determine the role of the user based on their credentials, such as by defining which department or sector the user operates in within the enterprise (e.g., sales, marketing, shipping/receiving, management, etc.).

In some embodiments, the data integration module 214 is configured to receive information stored in the various databases in communication with the application program 200 as described in FIG. 3 herein. The data integration module 214 receives various data points and processes the data and determine a suitable report to generate via the report module 222. The reports may include reports which relate to individual users (i.e., employees), departments (e.g., sales, marketing, shipping/receiving, etc.), sales metrics, invoice information, and the like.

In some embodiments, the display module 216 is configured to display one or more graphic user interfaces, including, e.g., one or more user interfaces, one or more consumer interfaces, one or more video presenter interfaces, etc. In some embodiments, the display module 216 is configured to temporarily generate and display various pieces of information in response to one or more commands or operations. The various pieces of information or data generated and displayed may be transiently generated and displayed, and the displayed content in the display module 216 may be refreshed and replaced with different content upon the receipt of different commands or operations in some embodiments. In such embodiments, the various pieces of information generated and displayed in a display module 216 may not be persistently stored. The display module 216 may be in communication with the augmented reality module 214 to display the video feed in real time.

In some embodiments, the display module 216 receives information from the data integration module 214 and reports generated thereby. The display module may then display the reports via the graphical user interface, on a vision board, or other representation of the aggregated data. The data representations may be provided in the form of reports, as described herein, and may include graphical displays, actual revenue, pacing revenue, projected revenue, service metrics, product installation metrics, inbound communication metrics, outbound communication metrics, etc. The vision board may be generated by a machine learning engine operating a machine learning algorithm.

In some embodiments, the sales module 218 receives salesperson data, product data, sales cycle metrics and other information related to the sales cycle and personnel thereof to provide various data representations. The sales module 218 may be used by the users (e.g., sales personnel, sales managers, or personnel performing analytics) to analyze performance using the displayed KPI's, or to determine useful adjustments to business practices to increase KPI values and/or increase the efficiency in which the enterprise operates. Further, the sales module 218 may be in communication with the machine learning engine 210 to autonomously or semi-autonomously determine and recommend more efficient business practices, recommend new sales strategies, etc.

The KPI's may include live statistics (e.g., sales and revenue per period of time (day, week, month, year), average sales, average installation metrics, average service metrics, capacity by unit, top 5 rankings of employees, weather, reviews, and call metrics. Technician personnel KPI's can include completed revenue, total jobs, average jobs, leads set, leads sold, total lead sales, memberships sold, total sales, and lead conversion rates. Sales KPI's may include total sales, sales opportunities, closed opportunities, closed average sales, close rate, and average discounts. Customer Service Representative (CSR) KPI's may include calls taken, lead calls, inbound calls booked, inbound booking rate, customer email capture percentage, and revenue generated. Recall KPI's may include completed jobs, recalls caused, recall percentage, and average install time. Marketing KPI's may include campaign names, total jobs booked, generated revenue, close rate, campaign cost, and ROA's. Invoice KPI's may include job type, invoice date, days pending, and customer name. Map KPI's may include job type, status, location, and time working. Review KPI's may include star rating, reviews, jobs, review percentage, top job type, and bottom job type.

In some embodiments, the marketing module 220 receives marketing data, product data, marketing personnel metrics, and other information related to an enterprise's marketing campaigns and strategies from the marketing database. The marketing module 220 may be in operable communication with the machine learning engine 210 to autonomously or semi-autonomously determine and recommend more efficient business practices, recommend new marketing strategies, recommend the allocation of resources (money and/or personnel), etc.

In some embodiments, the report module 222 receives information from the various databases in communication with the application program 200 to generate various reports. Reports may be pre-selected by the user(s) before their generation and/or automatically generated based on user preferences, predefined reporting protocols (e.g., generating profit and loss reports at the end of each fiscal quarter), etc. Reports may include graphical displays, actual revenue, pacing revenue, projected revenue, service metrics, product installation metrics, inbound communication metrics, outbound communication metrics, etc.

In some embodiments, the analysis and forecasting module 224 allows the system, such as by directing the data integration module 214, sales module 218, marketing module 220, report module 222, etc. to input data and to generate a report which includes real-time metrics and projected metrics for each analysis category. For example, the analysis and forecasting module 224 may receive information from the sales module 218 and sales database to generate real-time sales metrics and projected sales metrics for a selected period of time.

FIG. 3 illustrates the computing system 100 in operable communication with the application program 200 having a plurality of databases in communication thereto. A user database 300 is operable to store user information such as user preferences, user profile information, historical usage data, historical content, communications information, etc. The user database 300 may store individual user metrics (e.g., if the user is a salesperson, the user database may store sales information specific to that user), user preferences, user roles and permissions, etc. The sales database 310 stores sales metrics for the enterprise including sales history, sales related to particular products and/or services, sales personnel metrics, and other sales information. The marketing database 320 stores marketing metrics including marketing analytics, marketing strategies, marketing budgets, marketing analytics, and the like. The technical database 330 stores technical support metrics and related information including product installation information, product maintenance information, and the like. The report database 340 stores various reports generated by the system. The review database 350 stores reviews submitted by customers of the business.

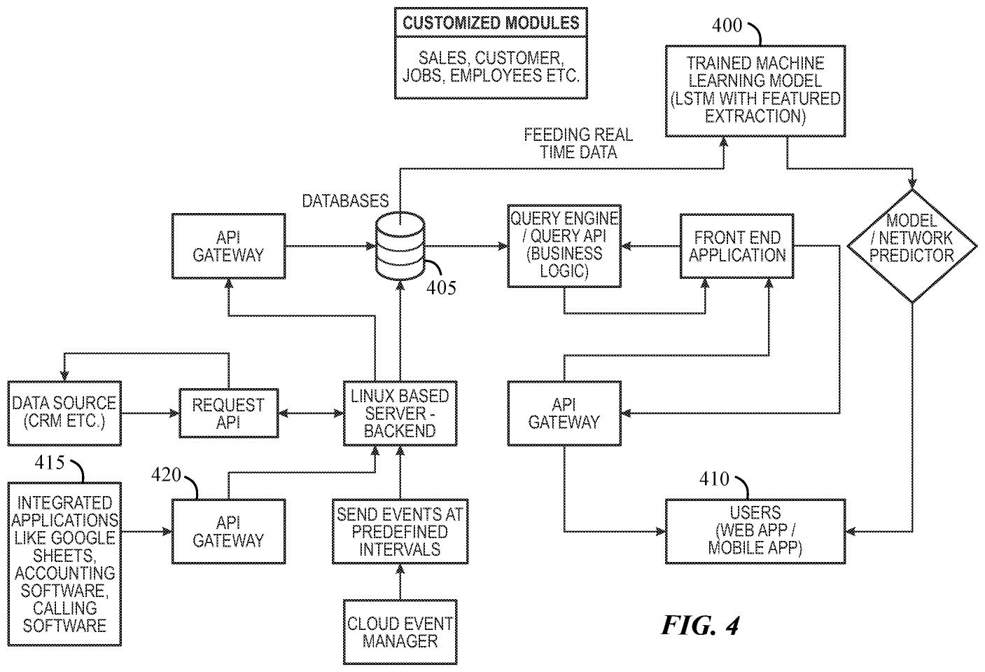

FIG. 4 illustrates a block diagram which illustrates the data flow within the system. The modules described in FIG. 2 are in communication with the database illustrated in FIG. 3. Each distributed information to the machine learning engine 400 via the application server 405. The machine learning engine 400 is in communication with a model/network predictor to distribute the predicted model to the users 410 via the application program. Integrated applications 415 may be in operable communication with the system via the API gateway 420 to distribute information the users 410.

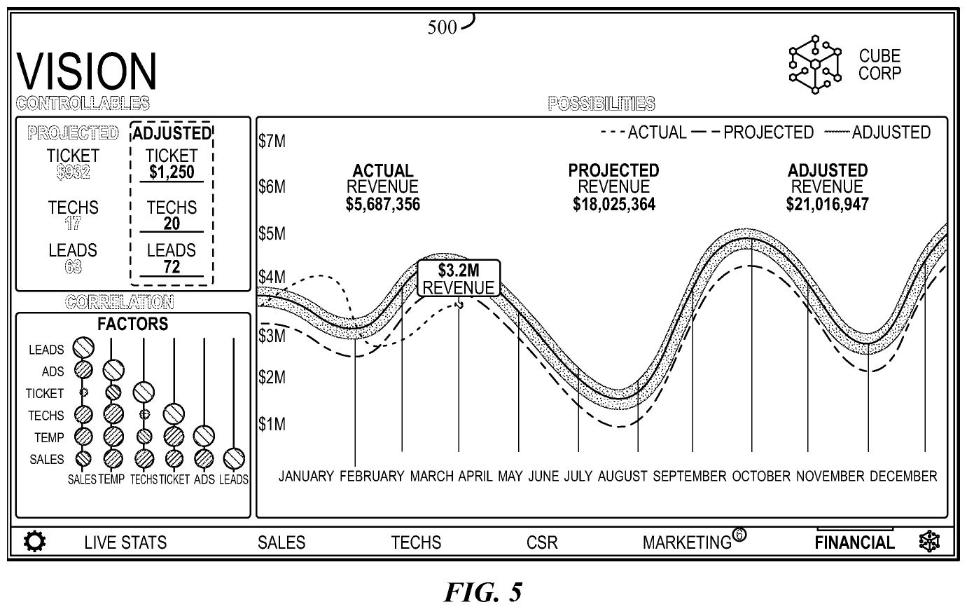

FIG. 5 illustrates a report 500 generated by the report module. The exemplary report 500 may include various metrics including historical and adjusted metrics, correlation factor metrics, actual revenue, pacing revenue, and projected revenue. For example, historical and adjusted metrics may include ticket values, total technicians involved in the ticket, leads, and other relevant information. Correlation factor metrics can include leads, advertisements, tickets, technicians, sales, etc. The correlation factor metrics may be displayed measured historically, in real-time, or in projected values. Each of the actual revenue values, pacing revenue values, and projected revenue values may be displayed as a graphical representation or other useful representation of the data. In some embodiments, the report 500 is generated by the machine learning algorithm operated by a machine learning engine.

In some embodiments, the report 500 (e.g., a vision board) may be displayed using virtual reality or augmented reality displays, such as by using augmented reality and/or virtual reality headsets or glasses.

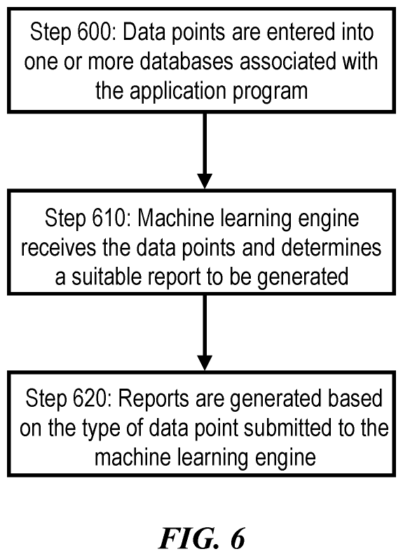

FIG. 6 illustrates a flowchart of a process for generating a report. In step 600, the data points are entered (either manually or automatically) into one or more databases associated with the application program. For example, sales metrics may be manually entered by a user (e.g., a salesperson) and stored in the sales database. In step 610, the machine learning engine receives the data points and determines a suitable report to be generated. In step 620, the report(s) are generated based on type of data point which has been submitted to the machine learning engine. For example, the report may be a sales report, marketing report, technical report, forecasting report, invoice report, recall report, review report, CSR report, live statistics report, or other report using the KPI's described hereinabove.

In some embodiments, the machine learning engine may provide recommendations that may improve the probability of creating a successful interaction, increase the efficiency of closing a sale, increase the likelihood of generating a sales opportunity, or making recommendations which otherwise making the business more efficient and profitable. While the example of the sales cycle is used herein, the machine learning engine may benefit all aspects of the business including marketing, technical support, etc. In one embodiment, the machine learning module aids a salesperson identify potential deals (e.g., sales opportunities) with existing and potential clients. In another embodiment, machine learning engine may recommend actions that help a salesperson identify the combination of sales team, sales items, and/or that would most likely lead to a successful sales experience.

In some embodiments, the system may help users identify and evaluate business opportunity prospects in an automated manner. The machine learning engine receives one or more input(s) used to identify business opportunities. These input(s) can comprise recent events gathered from external sources, for example news feeds from websites, and/or publicly-available business information compiled by third parties. Other inputs can comprise information from internal sources, such as Enterprise Resource Planning (ERM) and/or Customer Relationship Management (CRM) applications. Still other inputs can comprise personalized user preferences, for example assigned industry responsibility.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrase “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

What is claimed is:

1. A system for enterprise data analysis and forecasting, the system comprising:
at least one user computing device in operable connection with a network;
an application server in operable communication with the user network, the application server configured to host an application program for providing a system for enterprise data analysis and enterprise data forecasting, the application program having a user interface module for providing access to the application program through the user computing device; and
a machine learning engine for receiving a plurality of data points stored in one or more databases each in operable communication with the application program, the machine learning engine to process the plurality of data points and transmit the plurality of data points to a report module, the report module to generate one or more reports, the one or more reports permitting a user to analyze and forecast enterprise data.

2. The system of claim 1, wherein the one or more reports include actual revenue and projected revenue.

3. The system of claim 1, further comprising a sales database to store a plurality of sales metrics, the plurality of sales metrics transmitted to the machine learning engine to process the plurality of sales metrics and to generate a sales report.

4. The system of claim 1, further comprising a marketing database to store a plurality of marketing metrics, the plurality of marketing metrics transmitted to the machine learning engine to process the plurality of marketing metrics and to generate a marketing report.

5. The system of claim 1, further comprising a report database to store the one or more reports to permit the one or more reports to be viewed by the user.

6. The system of claim 1, further comprising a technical database to store a plurality of technical support metrics, the plurality of technical support metrics transmitted to the machine learning engine to process the plurality of technical support metrics and to generate a technical support report.

7. The system of claim 1, further comprising a review database to store a plurality of reviews provided by a third-party computing device, the plurality of reviews transmitted to the machine learning engine to process the plurality of reviews and to generate a review report.

8. A system for enterprise data analysis and forecasting, the system comprising:
at least one user computing device in operable connection with a network;
an application server in operable communication with the user network, the application server configured to host an application program for providing a system for enterprise data analysis and enterprise data forecasting, the application program having a user interface module for providing access to the application program through the user computing device;
a data integration module to receive a plurality of data points stored in one or more databases each in operable communication with the application program, the data integration module to determine a report to generate; and
a machine learning engine for receiving the plurality of data points via the data integration module, the machine learning engine to process the plurality of data points to generate the report via a report module.

9. The system of claim 8, further comprising a display module to display the report via an I/O device of a computer system.

10. The system of claim 8, wherein the one or more reports include actual revenue and projected revenue.

11. The system of claim 8, further comprising a sales database to store a plurality of sales metrics, the plurality of sales metrics transmitted to the machine learning engine to process the plurality of sales metrics and to generate a sales report.

12. The system of claim 8, further comprising a marketing database to store a plurality of marketing metrics, the plurality of marketing metrics transmitted to the machine learning engine to process the plurality of marketing metrics and to generate a marketing report.

13. The system of claim 8, further comprising a report database to store the one or more reports to permit the one or more reports to viewed by the user.

14. The system of claim 8, further comprising a technical database to store a plurality of technical support metrics, the plurality of technical support metrics transmitted to the machine learning engine to process the plurality of technical support metrics and to generate a technical support report.

15. The system of claim 8, further comprising a review database to store a plurality of reviews provided by a third-party computing device, the plurality of reviews transmitted to the machine learning engine to process the plurality of reviews and to generate a review report.

16. The system of claim 8, further comprising a communication module to transmit the report between one or more users.

17. A method for generating a report for analyzing and forecasting enterprise data, the method comprising the steps of:
a user entering a plurality of data points, the plurality of data points stored in one or more databases in communication with an application program;
receiving, via a machine learning module, the plurality of data points and determining a report to be generated;
generating, via a report module, the report; and
displaying the report via a display module.

18. The method of claim 17, further comprising a sales database, a marketing database, a report database, a technical database, and a review database.

19. The method of claim 17, further comprising the step of receiving, via a data integration module, the plurality of data points and determining the report to be generated.

20. The method of claim 17, further comprising the step of mapping, via a mapping engine, a visual map of the plurality of data points.
